(19) United States
(12) Patent Application Publication
(10) Pub. No.: US 2006/0089789 A1
(43) Pub. Date: Apr. 27, 2006

(54) Vehicle data logging systems

(76) Inventor: Derrick Arthur Bishop, Reston, VA (US)

Correspondence Address: Derrick Arthur Bishop, 1 Hayes Avenue, Tauranga, 3001, NZ

(21) Appl. No.: 10/502,793

(22) PCT Filed: Feb. 13, 2003
(86) PCT No.: PCT/NZ03/00024

§ 371 Date: Aug. 5, 2004

(30) Foreign Application Priority Data
Feb. 18, 2002 (NZ) 517268

(51) Int. Cl. G01C 21/26

(52) U.S. Cl. 701/207

(57) ABSTRACT

A data logging system for recording data on the usage of a vehicle operating from a station includes a responder (10) for location near a gateway (56) of the station, and a data logger (20) for location in the vehicle; the responder (10) including a vehicle detector (11) for detecting movement of a vehicle, and a transmitter (12) to transmit an identification signal (13) identifying the responder (10); the data logger (20) including a receiver (21) for receiving the identification signal, and a memory (22) to record responder identification data. The vehicle detector (10) may be a magnetometer to detect changes in magnetic field strength as a vehicle moves nearby. The data logger (20) may include a compass (41) to provide an indication of direction of travel and a vehicle operation sensor (47) or vehicle occupant sensor.

### FIELD OF THE INVENTION

This invention relates to the logging of data from vehicles and is particularly suited to the collection of data relating to the operation of a fleet of road vehicles.

### BACKGROUND OF TH INVENTION

The optimization of a fleet of vehicles depends, at least in part, upon the gathering of accurate data regarding the utilization of vehicles in that fleet. Data may be gathered manually or automatically.

In known manual systems, data on an individual vehicle operation, for example trip details such as dates, times, odometer readings, etc, have been manually recorded by the driver in a vehicle log book for subsequent analysis. Missing data or inaccuracies incorporated at time of data entry or subsequent transcription commonly occur in systems using manually logged data records.

Automatic data logging systems can monitor the presence or absence of a vehicle in a home base vehicle park, or if the vehicle is operating or moving. Systems using Global Positioning Systems (GPS) can determine the location of the vehicle but are more expensive than the current invention which uses different technology to obtain and record vehicle utilization data. GPS is also less reliable in areas where satellite signals can not be acquired (e.g. in concrete building car parks and when in close proximity to high rise buildings).

Automatic systems are used to electronically collect data relating to vehicle utilization and availability, without the need for manual data gathering processes. The data may be used in determinations or assessments of optimal vehicle numbers for vehicle fleets, fuel consumption, vehicle maintenance downtime and a wide range of other vehicle fleet management performance indicators.

An object of the invention is to provide a system and components which can automatically record data relating to vehicle usage and/or which at least provide the public with a useful choice.

Further objects and advantages of the invention will become apparent from the following description which is given by way of example.

### SUMMARY OF THE INVENTION

In accordance with a first aspect of the present invention, there is provided a data logging system for recording data relating to the usage of one or more vehicles of a fleet of vehicles operating from one or more stations, the data logging system including a responder for location in the vicinity of a gateway of one of the stations, and one or more data loggers for respective location in or on the vehicles;

wherein the responder includes

a vehicle detector for detecting movement of a vehicle nearby,

and a transmitter configured to transmit an identification signal identifying the responder following an output from the vehicle detector;

and each of the one or more data loggers includes

a logger receiver for receiving the identification signal,

and a memory;

and associated with each of the one or more data loggers a device configured to indicate when the vehicle is in operation and/or a device configured to indicate when the vehicle is occupied to provide vehicle usage data;

the memory configured to record responder identification data derived from the received identification signal and to record the vehicle usage data.

The device configured to indicate when the vehicle is in operation and/or the device configured to indicate when the vehicle is occupied may be part of the respective data logger. Alternatively, the device configured to indicate when the vehicle is in operation and/or the device configured to indicate when the vehicle is occupied may be operably connected to the respective data logger.

The transmitter is preferably configured to respond to output from the vehicle detector by transmitting the identification signal identifying the responder upon detection of a vehicle movement. In an alternative embodiment, the transmitter is configured to respond to output from the vehicle detector by transmitting an interrogation signal upon detection of a vehicle movement, and the responder further includes a receiver for receiving a response to the interrogation signal, the transmitter also configured to respond to output from the receiver by transmitting the identification signal identifying the responder upon receipt of a response to the interrogation signal by the receiver;

and the logger receiver of each of the one or more data loggers is configured to receive the interrogation signal, each of the one or more data loggers further including a logger transmitter configured to respond to output from the logger receiver by transmitting a response signal upon receipt of the interrogation signal by the logger receiver.

Preferably, the vehicle detector comprises a magnetometer that is sensitive to changes in the Earth's magnetic field.

Each of the one or more data loggers may include a compass which is sensitive to the direction of travel of the respective vehicle for providing an indication of whether the detected vehicle is entering or leaving the station, the indication being recorded with the identification data in the memory. The compass suitably comprises a magnetometer.

The transmitter of the responder may be configured to transmit a directional code which indicates an approximate bearing at which a vehicle must be travelling to be entering or leaving the station. Preferably, each of the one or more data loggers is configured to determine, based on the bearing on its compass and the directional code received from the responder, whether the vehicle is entering or leaving the station. Further, each of the one or more data loggers may be configured to determine, based on the bearing on its compass and the directional code received from the responder, whether the responder identification data should be recorded in the memory. In an alternative embodiment, the directional code associated with each responder can be recorded in the memory of each of the one or more data loggers, and upon receipt of the identification signal from the responder, the respective data logger may be configured to determine, based on the bearing on its compass and the directional code stored in its memory, whether the vehicle is entering or leaving the station.

Each of the one or more data loggers preferably includes a real time clock for providing time code signals which are recorded in the memory.

In a preferred embodiment, the device configured to indicate when the vehicle is in operation comprises a vehicle operation detector for providing an indication of whether the vehicle is being operated, the vehicle operation indication being recorded in the memory. The vehicle operation detector may be sensitive to vehicle engine vibrations, or sensitive to activation and deactivation of the vehicle's ignition or power system. The vehicle operation detector may comprise or be operably connected to the vehicle's ignition or power switch. Alternatively, the vehicle operation detector may be sensitive to changes in magnetic field strengths as the vehicle moves. The vehicle operation detector may comprise a magnetometer. Preferably, the magnetometer also functions as a compass which is sensitive to the direction of travel of the respective vehicle for providing an indication of whether the detected vehicle is entering or leaving the station, the indication being recorded with the identification data in the memory. The magnetometer may also function as a tachometer to detect the number of engine revolutions per minute for an electric engine.

The device configured to indicate when the vehicle is occupied may comprise a vehicle occupant detector for providing an indication of whether the vehicle is occupied by a driver, the vehicle occupant indication being recorded in the memory.

The responder may be powered from a storage device recharged from one or more solar cells.

The responder may be programmable with a delayed start to conserve power and minimise RF traffic.

In accordance with a second aspect of the present invention, there is provided a responder for use in a data logging system for recording data relating to the usage of one or more vehicles of a fleet of vehicles operating from a station, comprising:

a magnetometer which is sensitive to changes in the Earth's magnetic field for detecting movement of a vehicle nearby; and

a transmitter configured to transmit an identification signal identifying the responder following output from the magnetometer.

The transmitter may be configured to respond to output from the vehicle detector by transmitting the identification signal identifying the responder upon detection of a vehicle movement. Alternatively, the transmitter may be configured to respond to output from the vehicle detector by transmitting an interrogation signal upon detection of a vehicle movement, and the responder further includes a receiver for receiving a response to the interrogation signal, the transmitter also configured to respond to output from the receiver by transmitting the identification signal identifying the responder upon receipt of a response to the interrogation signal by the receiver.

Preferably, the transmitter is configured to transmit a directional code which indicates an approximate bearing at which a vehicle must be travelling to be entering or leaving the station.

The responder preferably includes a housing having a mounting part which is attachable to a support surface, the magnetometer mounted within the housing at an angle which is adjustable relative to the mounting part to maintain the magnetometer in a substantially horizontal configuration.

The responder preferably includes a housing having a mounting part which is attachable to a support surface, and further including one or more solar cells for charging a storage device which powers the responder, the angle of the solar cell(s) being adjustable relative to the mounting part.

In accordance with a third aspect of the present invention, there is provided a data logger for recording data relating to the usage of one or more vehicles of a fleet of vehicles operating from one or more stations, comprising:

a logger receiver for receiving an identification signal;

a compass which is sensitive to the direction of travel of the vehicle for providing an indication of whether the vehicle is entering or leaving the station; and

a memory configured to record identification data derived from the received identification signal and data derived from the indication of whether the vehicle is entering or leaving the station.

Advantageously, the compass comprises a magnetometer.

In a preferred embodiment, the receiver is configured to receive a directional code from a responder which indicates an approximate bearing at which a vehicle must be travelling to be entering or leaving the station, and the data logger is configured to determine, based on the bearing on its compass and the directional code received from the responder, whether the vehicle is entering or leaving the station. The data logger is preferably configured to determine, based on the bearing on its compass and the directional code received from the responder, whether the responder identification data should be recorded in the memory. Alternatively, the directional code associated with each responder can be noted after installation of the responder and stored in the memory of the data logger, and upon receipt of the identification signal from the responder, the data logger may be configured to determine, based on the bearing on its compass and the directional code stored in its memory, whether the vehicle is entering or leaving the station.

The data logger suitably includes a real time clock for providing time code signals which are recorded in the memory.

The data logger may include or be provided in combination with a device configured to indicate when the vehicle is in operation and/or a device configured to indicate when the vehicle is occupied to provide vehicle usage data, and the memory may be configured to record the vehicle usage data. In one embodiment, the device configured to indicate when the vehicle is in operation may comprise a vehicle operation detector for providing an indication of whether the vehicle is being operated, the vehicle operation indication being recorded in the memory. The vehicle operation detector may be sensitive to activation and deactivation of the vehicle's ignition or power system. In one embodiment, the operation detector may comprise or be operably connected to the vehicle's ignition or power switch. Alternatively, the vehicle operation detector may be sensitive to vehicle engine vibrations or changes in magnetic field strengths as the vehicle moves. The vehicle operation detector preferably comprises a magnetometer. Preferably, the magnetometer also functions as a compass which is sensitive to the direction of travel of the respective vehicle for providing an indication of whether the detected vehicle is entering or leaving the station, the indication being recorded with the identification data in the memory. Preferably, the magnetometer also functions as a tachometer to detect the number of engine revolutions per minute for an electric engine.

The device configured to indicate when the vehicle is occupied may comprise a vehicle occupant detector for providing an indication of whether the vehicle is occupied by a driver, the vehicle occupant indication being recorded in the memory.

The data logger preferably includes a mounting part for mounting in a cigarette lighter socket of a vehicle to power the data logger.

As used in this specification, “cigarette lighter socket” includes other electrical accessory sockets.

Preferably, the data logger includes a mechanical locking mechanism to selectively lock the mounting part in the cigarette lighter socket of the vehicle. The mechanical locking mechanism suitably includes one or more retractable barbs which are engageable with the interior of the cigarette lighter socket of the vehicle.

In a particularly preferred embodiment, the data logger includes a cigarette lighter socket so that another device can draw power from the data logger when it is plugged into the cigarette lighter socket of a vehicle.

In accordance with a fourth aspect of the present invention, there is provided a data logger for recording data relating to the usage of one or more vehicles of a fleet of vehicles operating from one or more stations, comprising:

a housing having a mounting part for receipt in a cigarette lighter socket of a vehicle for powering the data logger;

and mounted within the housing a logger receiver for receiving an identification signal and a memory configured to record identification data derived from the received identification signal and the indication of whether the vehicle is entering or leaving the station;

the housing including a cigarette lighter socket for receipt of another device requiring power when the data logger is plugged into the cigarette lighter socket of the vehicle.

The data logger preferably includes a mechanical locking mechanism to selectively lock the mounting in the cigarette lighter socket of the vehicle. The mechanical locking mechanism preferably includes one or more retractable barbs which are engageable with the interior of the lighter socket of the vehicle.

Preferably, the barb(s) is pivotally mounted to a mounting member, which is mounted on a rotatable threaded member such that rotation of the threaded member results in movement of the mounting member and thereby movement of the barb(s). The data logger preferably includes an adjusting head operably connected to the threaded member, such that rotation of the head results in rotation of the threaded member. In a preferred embodiment, the adjusting head is located in the cigarette lighter socket in the housing of the data logger.

The angle between the mounting part and the remainder of the housing is preferably adjustable.

The invention may also be broadly considered to consist in the parts, elements and features included in this specification, and in any combination of those parts, elements and features. Where specific parts, elements and features referred to in this specification have known equivalents in the related art, such known equivalents are to be understood as being included in this specification as if they had been specifically described herein.

Further aspects of the invention which should be considered in all its novel aspects will become apparent from the following description.

### BRIEF DESCRIPTION OF THE DRAWINGS

Examples of the invention will now be described with reference to the accompanying drawings, in which:

FIG. 1 shows a block diagram of a first preferred embodiment of a data logging system;

FIG. 2 shows a block diagram of a second preferred embodiment of a data logging system;

FIG. 3 shows a block diagram of a responder of a data logging system;

FIG. 4 shows a block diagram of a data logger of a data logging system;

FIG. 5 shows a site plan of a station and associated roads monitored by a data logging system;

FIG. 6 shows a perspective view of a responder of a data logging system;

FIG. 7 shows an end view of the responder of FIG. 6 when mounted to a vertical surface;

FIG. 8 shows an end view of the responder of FIG. 6 when mounted to a horizontal surface; and

FIGS. 9a-c show a sectional plan view, sectional side view and front view of a preferred embodiment data logger for mounting in a cigarette lighter socket of a vehicle.

### DESCRIPTION OF THE PREFERRED EMBODIMENTS

Corresponding features shown in the Figures are generally labelled with like reference numerals.

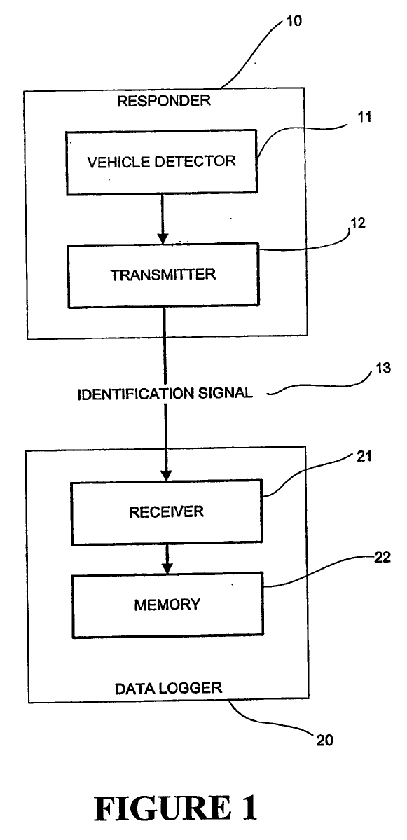

FIG. 1 shows a first preferred embodiment of a data logging system which includes a responder 10 and a data logger 20. In practice the system can include multiple responders and multiple data loggers, although for simplicity only one of each is shown in FIG. 1. The data logging system is suited to the gathering of data relating to the usage of vehicles in a fleet of vehicles. In use a responder is located at each gateway to a station such as a home base vehicle park for vehicles in a fleet to be monitored, and a data logger is fitted in or on each “target” vehicle of the fleet. References in this specification to “gateway” are to be understood as including any entrance or exit by which a vehicle enters or leaves the zone or station being monitored, and are not to be limited to entrances or exits having a gate or equivalent structure. A “target” vehicle is one which is part of the fleet being monitored and is fitted with a data logger allocated to that vehicle.

The responder 10 responds to the presence or movement of a nearby vehicle by transmitting an identification signal. The responder 10 includes a vehicle detector 11 and a transmitter 12. The vehicle detector is sensitive to the presence or movement of a vehicle in the vicinity of the detector. The transmitter is responsive to the output of the detector and transmits a signal 13 identifying the responder when the detector indicates that a vehicle is in or moving through the vicinity of the responder.

The data logger 20 includes a receiver 21 for receiving the signal 13 identifying the responder. The receiver outputs data identifying the responder which is recorded in a memory 22 for subsequent download and analysis.

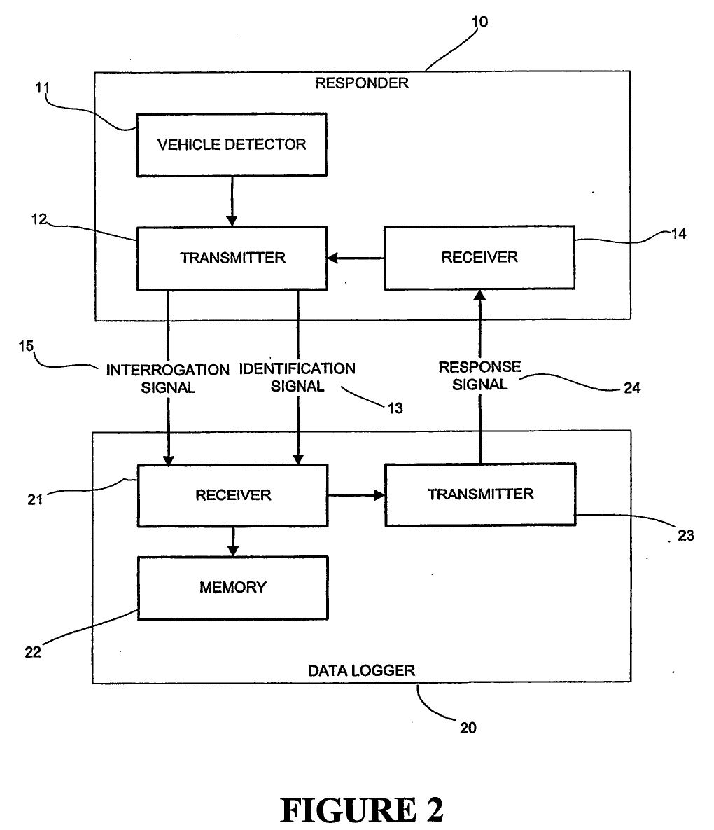

FIG. 2 shows a second preferred embodiment of a data logging system which includes a responder 10 and a data logger 20. As in the previous embodiment, only one responder and data logger are shown although multiple responders and loggers may be used in typical applications. In use a responder is located at each gateway to a station such as a home base vehicle park for vehicles in a fleet to be monitored, and a data logger is fitted in or on each “target” vehicle of the fleet.

The responder 10 of FIG. 2 includes a vehicle detector 11, a transmitter 12, and a receiver 14.

The vehicle detector 11 is sensitive to the presence or movement of a vehicle in the vicinity of the detector. The transmitter 12 is responsive to the output of the detector and transmits an interrogation signal 15 when the detector indicates that a vehicle is in or is moving through the vicinity of the responder.

The data logger 20 of FIG. 2 includes a receiver 21 for receiving the interrogation signal 15. Upon receipt of an interrogation signal the data logger receiver triggers a transmitter 23 to transmit a response signal 24. Upon receipt of the response signal by the receiver 14 in the responder, the responder transmitter 12 transmits a signal 13 identifying the responder.

The data logger receiver 21 receives the signal 13 identifying the responder 10 and outputs data identifying the responder which is recorded in a memory 22 for subsequent download and analysis.

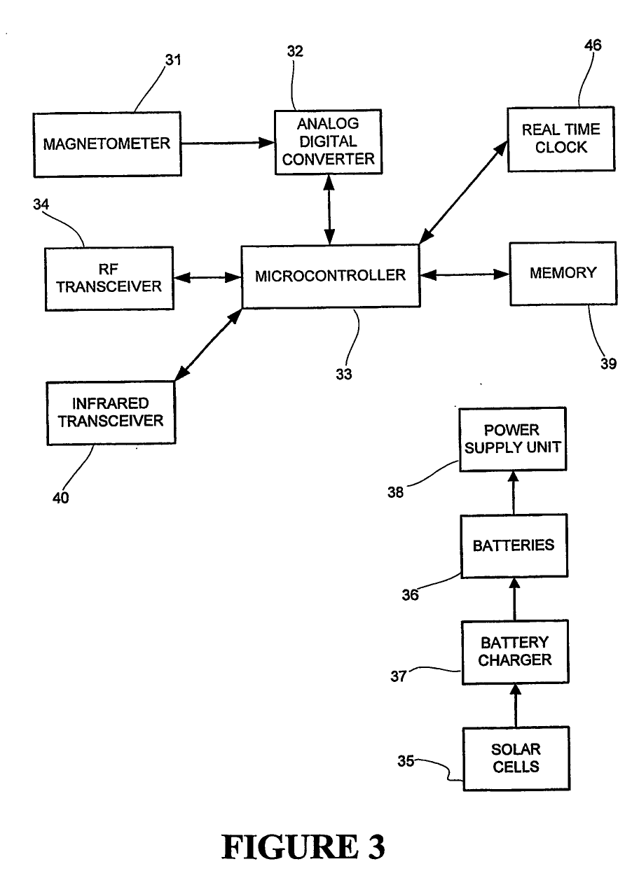

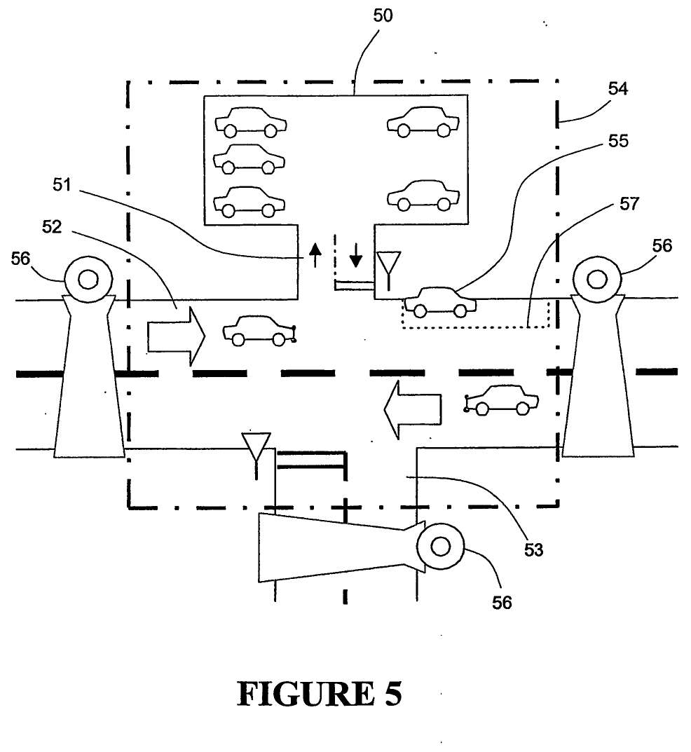

FIG. 3 shows a responder for a data logging system, such as that shown in FIG. 2, in more detail. Responders are located at respective gateways or entrances/exits of a zone which may include a designated vehicle park for a fleet of vehicles, and may also include roadways and parking areas near but outside the designated vehicle park. This may be better appreciated by reference to FIG. 5 which is discussed in further detail below.

The vehicle detector of the responder shown in FIG. 3 is provided by a magnetometer 31 which is sensitive to changes in the Earth's magnetic field occurring when a large metallic object, such as a vehicle, moves in the vicinity of the magnetometer. The use of a magnetometer allows the responder to detect a passing vehicle even if other vehicles are parked in front of or over the responder, i.e. a direct “line of sight” from the responder is not necessary to detect passing vehicles. The magnetometer provides a detection range of approximately 10 to 20 metres, meaning the responder can be distanced from the road thereby reducing the likelihood of damage. This has the added benefit of improving staff safety as the responder installation and/or removal can be distanced from oncoming traffic, thereby reducing the risk of staff being exposed to vehicle impact.

If necessary, two responders may be provided on opposite sides of the road if the road is sufficiently wide that it is not covered by the detection range of a single responder.

An analogue to digital converter 32 translates output from the magnetometer to a digital format suitable for input to a microcontroller 33.

Upon receipt of a signal derived from the magnetometer 31 indicating that a vehicle is moving in the vicinity of the responder, the microcontroller 33 commands a transceiver 34 to transmit an interrogation signal. In one embodiment, the interrogation signal may be a partial or abridged signal, e.g. a 1 byte signal, which includes a unique code identifying the responder.

If the passing vehicle is a “target” vehicle, the on-vehicle data logger will detect the interrogation signal 15 and transmit a response signal 24 as will be further explained below.

Any response signal received by the responder transceiver 34 is checked to determine if it is from a “target” vehicle. If the response signal is valid, the responder then transmits a full signal 13, e.g. a complete data packet including a unique responder identification code. The data packet transmitted from the responder may be repeated to reduce the likelihood of errors upon reception by the on-vehicle data logger.

The responder transceiver 34 preferably transmits and receives radio frequency (RF) signals.

The use of a partial initial interrogation signal to elicit a response for validation before sending a full signal reduces the energy required by the responder, by avoiding the sending of full signals in response to detection of passing vehicles other than the target vehicles.

In addition to, or instead of, the partial/full signalling described above, responder power savings may be implemented by the initial signal, issued by the responder upon detecting vehicle movement, being a low-strength signal with the subsequent signal, issued after validation of a response from a “target” vehicle, being a full-strength signal.

It is not essential that the initial interrogation signal is a low-strength signal or a partial signal. Rather, the initial interrogation signal could be a full strength signal, which will be detected by a data logger of a “target” vehicle, which will transmit a response signal.

Again, any response signal received by the responder transceiver 34 is checked to determine if it is from a “target” vehicle. If the response signal is valid, the responder then transmits an identification signal (a signal including a unique responder identification code).

Further, it is not essential for the responder to transmit an interrogation signal, or for the data logger to be configured to transmit a response signal. Rather, upon detection of vehicle movement, the responder could simply be configured to transmit an identification signal which will be received by the data logger in a “target” vehicle. The system of FIG. 1 does not rely on an interrogation signal.

The responder includes solar cells 35 which charge batteries 36 via a charger 37. The batteries provide power to the responder power supply unit 38 which provides power to the responder components discussed elsewhere. Other power sources could be used if desired.

The responder includes a memory 39 for storage of programmed project start and stop times, identification codes for the responder and for loggers to be validated during a designated data logging project.

In contrast to known systems which draw currents of 1 A or more, the responder has a low power consumption, drawing a supply current of about 10 mA, and can be powered from solar cells. This allows responders to be located in remote locations without the need for mains power supply or large storage batteries. The use of a magnetometer as the vehicle detector provides a significant power saving as it eliminates the need for high power consuming road loops and other induction-based technology.

However, induction loop, microwave or pressure sensors or similar could be used as the vehicle detector if desired.

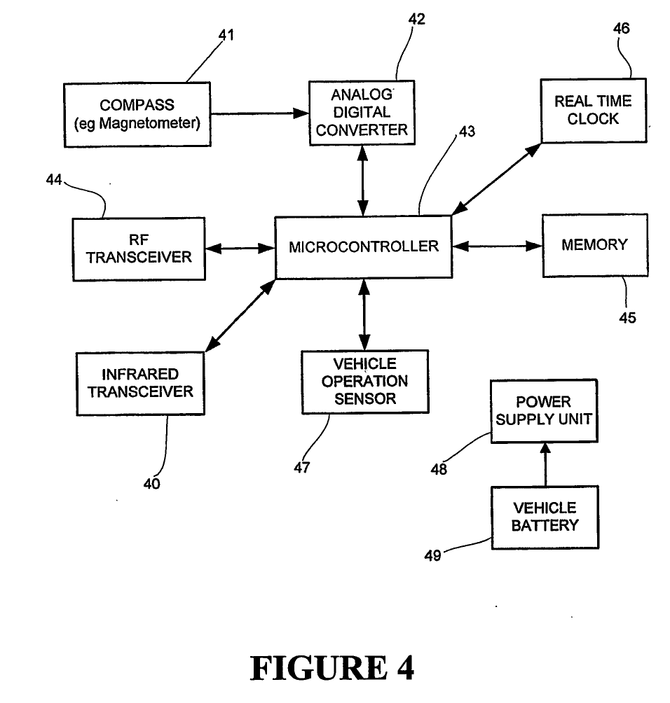

FIG. 4 shows a data logger of a data logging system, such as that shown in FIG. 2, in more detail. Data loggers are installed in or on respective “target” vehicles of the fleet being monitored.

The data logger of FIG. 4 includes a transceiver 44 for receiving the interrogation signal transmitted by the responder. A microcontroller 43 checks the received interrogation signal 15 and, if it includes identification of a responder allocated to the data logging system, the microcontroller 43 commands the transceiver 44 to transmit a response signal 24 identifying the data logger.

Upon receipt by the transceiver 44 of a further signal identifying the responder, the microcontroller validates the signal as coming from an associated responder and records the date, time, responder identification code, and optionally the direction of travel in a memory 45. In one embodiment, the memory is a 2 M-bit memory allowing for approximately 18,000 events to be recorded.

The date and time are obtained from a real time clock 46 connected to the microcontroller. The orientation of the vehicle is derived from a compass 41, e.g. a magnetometer or other electronic compass device, which is connected to the microcontroller 43 via an analog to digital converter 42. The orientation of the vehicle as determined by the compass, in conjunction with identification of the particular responder, is used to provide an indication whether the vehicle is entering- or leaving the zone monitored by the responder(s) at the zone gateways.

The use of an electronic compass allows the determination of whether the vehicle is entering or leaving the monitored zone with only a single responder at each gateway, saving hardware costs and installation time, and reducing the likelihood of interference from cross-talk from other responders.

The data logger may include a device configured to indicate when the vehicle is in operation and/or a device configured to indicate when the vehicle is occupied to provide vehicle usage data. The device may be a vehicle operation sensor 47 for detecting whether the vehicle, in which the logger is installed, is in operation. The vehicle operation sensor 47 is connected to the microcontroller 43 which records, in the memory 45, the date and time that each vehicle operation begins and ends. This recording of data occurs whether the usage is to or from the home zone or is entirely outside the home zone.

The start and finish times of each vehicle operation or running time provide information on the duration and time of day of that usage.

Although in one embodiment the vehicle operation sensor is a vibration sensor that is sensitive to vibrations of the vehicle engine, it is envisaged that other operation sensors may be used to determine if the vehicle is being used. An alterative vehicle operation sensor is sensitive to activation and deactivation of the vehicle's ignition or power system. The vehicle operation detector may comprise or be operably connected to the vehicle's ignition or power switch. Another suitable type of vehicle operation sensor will detect changes in magnetic fields while the vehicle is moving. Such a sensor will be useful in the case of electric vehicles where a vibration sensor may be unreliable given the low level of vibration arising from electric motors. The sensor to detect changes in magnetic fields while the vehicle is moving may be a magnetometer, and is preferably the same magnetometer as the compass. In the case of an electric vehicle, the magnetometer would detect a heightened electromagnetic field when the electric engine is operating.

If used in an electric vehicle, the magnetometer may also be used to perform tachometer measurements. An electric vehicle will emit variable electromagnetic field intensity as the electric motor rotates, thus indicating the number of revolutions per minute. Data from the tachometer can be used for determining diagnostic, performance and driver operation information, which is useful for fleet management. The tachometer data may be recorded by the data logger memory.

In addition to the above-mentioned sensors for monitoring vehicle operation, also envisaged is the use in the data logger of a sonic sensor to determine whether a person is occupying the driver's seat of the vehicle. Such a sensor can use very inexpensive ultrasonic sonar technology in which a sonic transducer, e.g. mounted on or in the vicinity of the dashboard of the vehicle, is used to monitor the clear distance between the transducer and the driver's seat. This clear distance will change if someone occupies the seat, indicating that the vehicle is occupied and being used. Other sensors could detect weight, heat, CO₂ (from human breath), or displacement, the latter monitoring displacement caused by an occupant in the vehicle driver's seat. All of these sensors would determine whether the driver's seat is occupied, thereby giving an indication of when the vehicle is occupied and being used. Such sensors could be provided in addition to or instead of a vehicle operation sensor.

It will be appreciated that the device configured to indicate when the vehicle is in operation and/or occupied could be provided within part of a main data logger housing, or could be provided in the vehicle separately from the data logger but operably connected thereto. For example, it may be desirable to have a vibration detector under the bonnet of the vehicle but electrically connected to the data logger. Alternatively, the communication could be via RF or infrared for example. Similarly, a vehicle occupant detector could be provided in the region of the driver's seat of the vehicle but connected to the data logger. Both options are covered by this specification.

By providing a system having a responder to send an identification signal and a data logger to receive the signal and record identification data, and a device configured to indicate when the vehicle is in operation or occupied to provide vehicle usage data, the system can not only record when the vehicle is in our out of a home zone, but can also detect and record when the vehicle is actually being driven or is occupied whether inside or outside the home zone. This will give an indication of whether a vehicle is being used efficiently—i.e. the proportion of time out of the home zone that the vehicle is actually being driven or occupied. Such data can be used to determine whether more or less vehicles are needed, can provide audit capabilities for personal vehicle usage claims, and can also be used to reconfigure how organisations schedule their workloads.

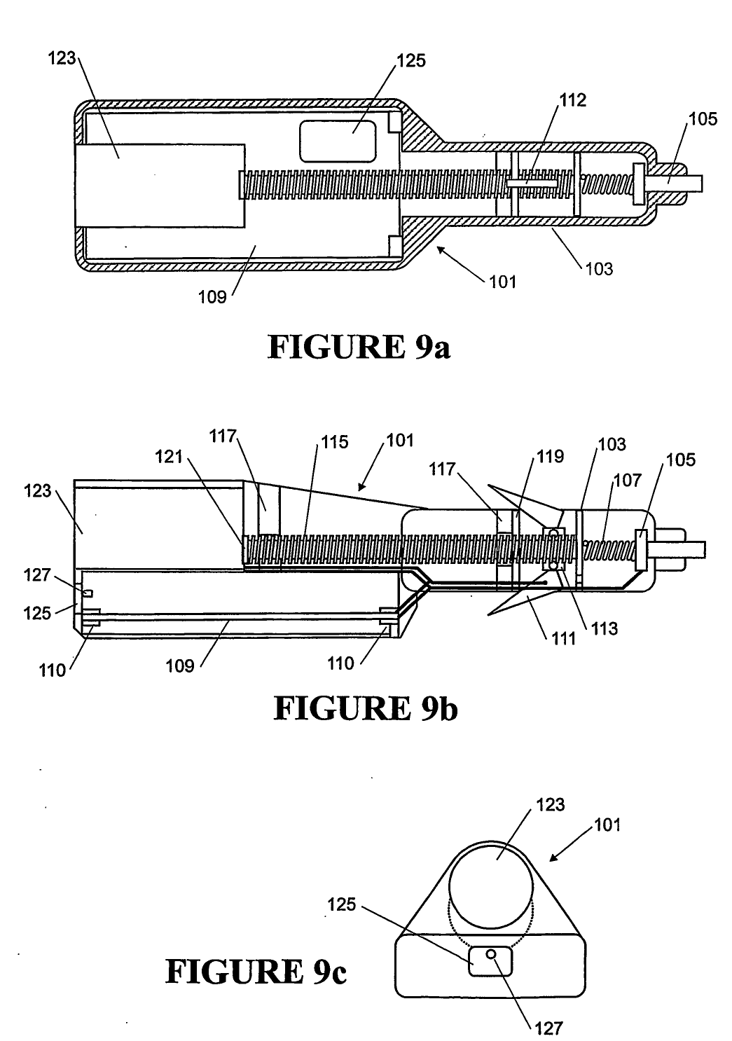

A data logger as described is installed and carried onboard each target vehicle of the fleet being monitored, for the duration of a data collection period, so that individual vehicle data can be collected. The data logger is normally mounted in the engine bay of the target vehicle, on the inside of the front windscreen, or extending from a cigarette lighter socket, and includes a power supply unit 48 which may be powered from the vehicle power supply, e.g. a 12V or 36V vehicle battery 49. The location of the data logger in or on the target vehicle is not important, so long as the transceiver operation is adequate to operate a communication link with a roadside responder. A preferred data logger for mounting in a cigarette lighter socket is described below with reference to FIGS. 9a-c.

In an alternative power supply arrangement, the data logger may be fitted with a super capacitor to store power which maintains operation of the real time clock if the vehicle battery goes flat, or is disconnected or removed from the vehicle, such as may occur during maintenance, or if the data logger is transferred to another vehicle. The supercapacitor can power the real time clock for about 30 days while the data logger is disconnected from the vehicle battery supply.

The responder of FIG. 3 and the data logger of FIG. 4 each include an infrared transceiver 40 by which data may be sent and received from a hand-held programming and download unit, which is discussed in further detail below. The infrared communications is preferably at short range so that other responders or data loggers do not pick up false signals. Infrared communication allows the responder or data logger to be totally sealed because no plugs or other connections are then required to provide a communications port. This reduces the susceptibility of the internal electronics to external humidity or to immersion of the logger in liquids.

As well as sending a responder identification code in the signal, the responder is preferably configured to send a directional code which indicates an approximate bearing at which a vehicle must be travelling to be entering or leaving the zone. If the vehicle logger has a compass, the microcontroller of the vehicle logger can compare the directional code received from the responder with the bearing from its compass, to determine and record in its memory whether the vehicle is leaving or entering the zone. For example, the responder may send an “in” direction code, which gives an indication of the approximate bearing of a vehicle which is driving into the zone. From that code, and the direction on the vehicle logger compass, the data logger microcontroller can determine whether the vehicle is entering or leaving the zone.

Further, the microcontroller in the data logger is preferably configured to determine, based on the relative angle between the vehicle and the bearing from the directional code, whether an event should be recorded in memory. For example, if a vehicle is undertaking a U-turn in the vicinity of a responder, the microprocessor will determine that, and will not record the identification code in memory, thereby minimising memory usage.

It is not necessary for the responder to send a directional code. Alternatively, upon installation of the responder, the directional code(s) for the responder can be determined by an installer and recorded. The directional code(s) could then be stored in the memory of the data loggers, e.g. prior to their installation in respective vehicles. When the identification code from a responder is received by a data logger, the data logger can determine from the responder identification code, responder installation direction data recorded in memory, and the vehicle compass reading whether it is entering or exiting the zone. As a further alternative, only the identification data and the vehicle direction data from the compass may be recorded in the data logger memory, and following download of the data from the data logger, this data could be compared with installation direction data (e.g. in a computer program or database) to determine whether the vehicle was entering or leaving a zone.

FIG. 5 shows a site plan of an example zone, including a vehicle station and associated streets or roads, monitored by a data logging system. In FIG. 5 the station is the home base car park or vehicle pool 50 in which vehicles of a fleet to be monitored are usually parked when not away from the home base. The vehicle pool has a driveway 51 linking to a nearby road 52, which links with a side road 53. The boundary of the “home zone” 54 is indicated by a broken line. Vehicles parked in the designated vehicle pool are considered to be in the home zone. A vehicle 55 parked outside the vehicle pool on a nearby road within the zone 54, e.g. in roadside parking area 57, is considered to be in the “home zone”. Broadening the home zone to include parking areas outside the designated vehicle pool parking area improves the accuracy of data by including in the accounting of vehicles at home base, any fleet vehicles parked nearby but outside the designated vehicle pool.

FIG. 5 shows three responders 56 located at respective gateways of the home zone. Each responder includes a vehicle detector, as discussed above, and is positioned in the roadside gutter or on the footpath for detecting movement of vehicles along the streets or roads at the gateways to the monitored zone, as will occur when vehicles leave or return to the home zone.

The responders respond to the passage of vehicles on the adjacent roadway by initiating a communication sequence between a respective responder and data logger installed in the passing vehicle, culminating with identification of the responder to the data logger. Each responder has a transmission/reception range of about a 25 metre radius. The responders are oriented to optimise any directivity in patterns of transmission or reception to face across the roadway that the responder is assigned to monitor.

An off-the-shelf hand-held or other programming unit, not shown, is used to communicate with the responders or data loggers preferably without direct electrical contact, e.g. by RF via the RF transceiver 34, 44 or infrared signals via infrared transceiver 40 shown in FIGS. 3 and 4, to initially load the responders and data loggers with information. A Palm Pilot or Pocket PC hand-held unit may be used for example. By this means the programming unit can load date/time parameters and configuration data to preset the functionality of the responders and data loggers. For example, the programming unit may be used to upload vehicle registration, start mileage, dates/times etc to the data loggers. The programming unit can also extract, from the data loggers, sample or limited data while in the field or full vehicle utilization data at the end of a fleet monitoring project, and can perform a wide range of administrative tasks or diagnostic tests.

The responders or data loggers can thus be configured with a project start date and time if desired. This is especially relevant to the responders so that they can remain in a low-power-consuming dormant or “sleep” mode to conserve power and minimise RF traffic until the start date/time of the project.

The programming unit can also be used to adjust or reset the internal real-time data logger clocks 46, shown in FIGS. 3 and 4, before the commencement of each new data logging project, to correct or at least partly offset inaccuracies in the internal responder and logger clocks.

Data loggers are installed in respective “target” vehicles of the fleet being monitored by the project and once the project start date and time are reached, the data loggers self activate and begin the data collection process. The programming unit may also hold data relating to which vehicles should have a data logger installed and their locations.

At the end of each project or assignment, the recorded data is downloaded from each data logger into the hand-held programming unit or other device for subsequent bulk download to a computer

Alternatively, the logger data can be downloaded directly to the computer. For example, at the end of the project or assignment, all of the data loggers may be installed in a power bank of cigarette lighter sockets, and the computer will individually call each data logger to perform its download. This process could occur continuously without human intervention until all loggers have downloaded to the computer. The computer can then analyse the data as required, e.g. for optimization of the vehicle fleet. Both the responder 10 and data logger 20 may use their respective infrared transceiver 40 or RF transceiver 34, 44 devices for performing upload and download functions. Other suitable communications types, such as Bluetooth, could be used to communicate with the computer or hand-held programming unit.

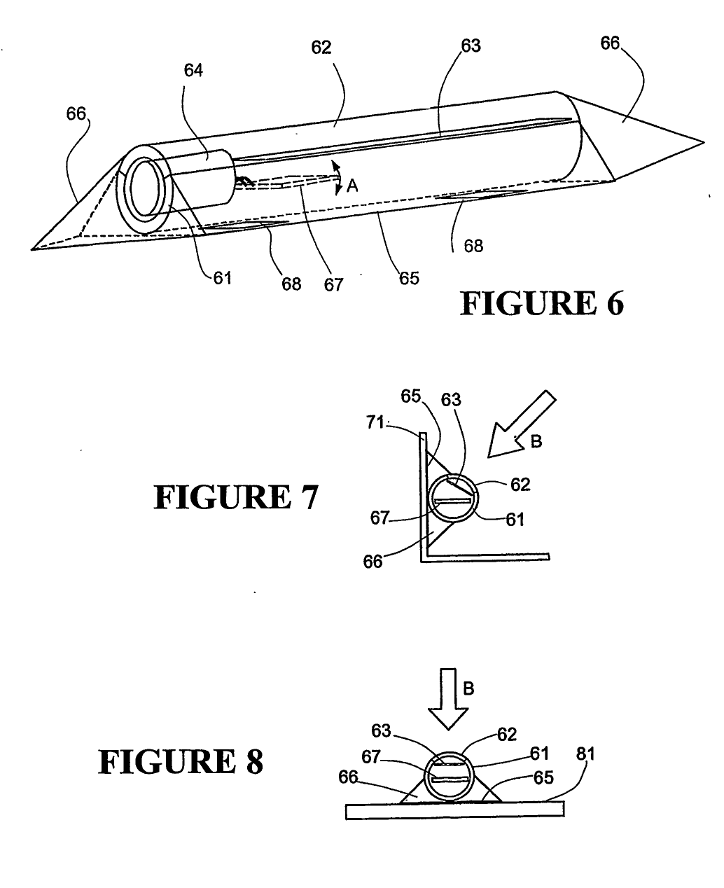

FIG. 6 shows a perspective side view of a responder of a data logging system. The responder is housed in a housing, which in the preferred embodiment shown is a tube 61 with a clear break-resistant window 62 that runs along the length of the housing to allow solar cells 63 to receive solar radiation for charging a storage battery 64. The window also allows infrared and/or RF communication between data logger and external devices, such as the hand-held programming device described above in conjunction with the data logger. The use of the window as a port for communications and charging the battery allows the responder to be completely self-contained in a fully sealed housing. The housing tube is preferably made from aluminium, with a polycarbonate or low-iron tempered glass window. It will be appreciated that non-tubular housings could be used if desired.

The housing tube is mounted in a support including a flat base 65 and two end pieces 66. The tube can be rotated relative to the support so that the angle of the solar cells can be altered to maximise power output to the storage battery. The vehicle-detecting magnetometer and other circuit components are carried on a circuit board 67 which is rotatable relative to the housing, as indicated by arrow A in FIG. 6, so that the orientation of the magnetometer and other circuit components may be maintained substantially horizontal. The vehicle-detecting sensitivity of the magnetometer is maximised by maintaining the detector in a horizontal orientation.

The responder is designed to withstand crushing and impact forces from heavy vehicles or vandalism. So that the magnetometer or other vehicle detector can readily detect passing vehicles, the responder is best located close to the road at a gateway to the zone being monitored. The responder is conveniently attached to a surface of the roadside gutter or another suitable surface. The responder is preferably attached to the vertical wall of the gutter to allow water and debris to flow unhindered along the gutter, and so that the solar cells can access adequate sunlight.

A wide range of adhesive products are suitable for attaching the responder to the gutter surface. A “hot melt” adhesive is particularly suitable. For this purpose the base 65 of the responder support is provided externally with electrically resistive heating pads 68 that, when connected to an external 12 volt battery, heat the hot melt adhesive to facilitate attachment and subsequent removal of the responder. Alternatively, strong but removable adhesives, bolts or other anchoring products can be used to attach the responder to a surface.

FIGS. 7 and 8 show end views of the responder of FIG. 6 when mounted to the vertical wall of a roadside gutter 71, and to a horizontal surface 81, respectively. Components corresponding to those already discussed in respect of FIG. 6, are labelled similarly. Arrows B are indicative of the solar radiation that penetrates the window 62 to activate the solar cells 63 for charging of the storage battery.

A preferred data logger for mounting in a cigarette lighter socket of a vehicle is shown in FIGS. 9a-c. The data logger has a housing 101 with a mounting part 103 which is receivable in a conventional lighter socket in a car. The mounting part 103 also has a positive connector 105 which is biased outwardly from the mounting part by a spring 107. The connector 105 is in electrical connection with a printed circuit board 109 which carries the components of the logger and is mounted within PCB guides 110.

The data logger includes a mechanical locking mechanism, which prevents the data logger from being removed from the socket during a project. In the form shown, the locking mechanism includes a pair of barbs 111 which are pivotally attached to a mounting member 113 which is moved via rotation of a threaded member 115. The barbs 111 extend through slots 112 in the mounting part 103. As the threaded member is rotated clockwise, the mounting member 113 moves towards the thread guide 117 and washer 119, such that the barbs 111 pivot outwardly to engage the inside of the lighter socket. With the barbs 111 pivoted outwardly, the data logger cannot be removed from the lighter socket. When the threaded member is rotated in an anticlockwise direction, the barbs will move back in to enable the data logger to be released from within the lighter socket. A suitable adjusting head 121 is provided to enable rotation of the threaded member 115. The adjusting head 121 is preferably a non-standard head so that a specialised tool or key must be used to remove the data logger from the lighter socket.

In the embodiment shown, the barbs also act to earth the device, and are in electrical connection with the printed circuit board 109. For this reason, the barbs 111 are preferably metallic components, and the threaded member 115 an insulating plastic component.

A further cigarette lighter socket 123 extends into the end of the housing 101 opposite to the mounting part 103, so that another accessory such as a mobile phone charger, can access power while the data logger is plugged into the cigarette lighter socket of the vehicle. In the embodiment shown, the adjusting head 121 of the threaded member is accessible through the interior of the cigarette lighter socket 123 when it is not being used.

Although not shown in the Figures, the printed circuit board 109 will carry components including the memory, transceiver, microcontroller, compass or magnetometer, and vehicle operation or vehicle occupant detector as described above. In the embodiment shown, an RF loop antenna 125 is provided for the transceiver.

An infrared lens 125 is provided in the front face of the logger to enable communication with a hand-held programming and download unit or a computer.

As the data logger contains an RF loop antenna and a compass which should be substantially horizontal for effective operation, a swivel portion may be provided between the mounting part 103 and the part of the housing 101 containing these components. This will enable the logger to be mounted in a vertical lighter socket as provided in some vehicles.

The data loggers and responders are designed for extreme weather conditions, e.g. a temperature range from −40° C. to +85° C., for operation all year round and in harsh climatic conditions.

The system has been described in relation to the electronic collection of data from cars or automobiles, but it can be applied to other fleet vehicles, e.g. trucks, and even unpowered driverless vehicles such as towed trailers, or freight or shipping containers. Although the examples described relate to the collection of data for the optimization of vehicle utilization, the system can be applied to the collection of data for the purposes of tracking freight or determination of compliance with regulatory requirements or road taxes.

In the example collection of vehicle utilization data described above, the responders and loggers are normally temporarily installed in vehicles and on roadside locations adjacent gateways to home zones, and removed upon completion of the data gathering phase of the project. The responders and loggers have been designed to be readily installed and removed for reuse on later projects.

Particular examples have been described and where in the foregoing description alternatives are available these are considered to be incorporated, although not specifically mentioned. For example, references to vehicles are to be understood as including where appropriate, but not be limited to, cars, vans, trucks, trailers, etc. Modifications may be made to the example described above without departing from the scope of the following claims.

1. A data logging system for recording data relating to the usage of one or more vehicles of a fleet of vehicles operating from one or more stations, the data logging system comprising a responder for location in the vicinity of a gateway Of one of the stations, and one or more data loggers for respective location in or on the vehicles;
wherein the responder comprises
a vehicle detector for detecting movement of a vehicle nearby,
and a transmitter configured to transmit an identification signal identifying the responder following an output from the vehicle detector;
and each of the one or more data loggers comprises
a logger receiver for receiving the identification signal,
and a memory;
and associated with each of the one or more vehicles a device configured to indicate when the vehicle is in operation and/or a device configured to indicate when the vehicle is occupied to provide vehicle usage data;
the memory configured to record responder identification data derived from the received identification signal and to record the vehicle usage data.

2. The data logging system as claimed in claim 1, wherein the device configured to indicate when the vehicle is in operation and/or the device configured to indicate when the vehicle is occupied is part of the respective data logger.

3. The data logging system as claimed in claim 1, wherein the device configured to indicate when the vehicle is in operation and/or the device configured to indicate when the vehicle is occupied is operably connected to the respective data logger.

4. A data logging system as claimed in claim 1, wherein the transmitter is configured to respond to output from the vehicle detector by transmitting the identification signal identifying the responder upon detection of a vehicle movement.

5. A data logging system as claimed in claim 1, wherein the transmitter is configured to respond to output from the vehicle detector by transmitting an interrogation signal upon detection of a vehicle movement, and the responder further comprises a receiver for receiving a response to the interrogation signal, the transmitter also configured to respond to output from the receiver by transmitting the identification signal identifying the responder upon receipt of a response to the interrogation signal by the receiver;
and the logger receiver of each of the one or more data loggers is configured to receive the interrogation signal, each of the one or more data loggers further comprising a logger transmitter configured to respond to output from the logger receiver by transmitting a response signal upon receipt of the interrogation signal by the logger receiver.

6. A data logging system as claimed in claim 1, wherein the vehicle detector comprises a magnetometer that is sensitive to changes in the Earth's magnetic field.

7. A data logging system as claimed in claim 1, wherein each of the one or more data loggers includes a compass which is sensitive to the direction of travel of the respective vehicle for providing an indication of whether the detected vehicle is entering or leaving the station, the indication being recorded with the identification data in the memory.

8. A data logging system as claimed in claim 7, wherein the compass comprises a magnetometer.

9. A data logging system as claimed in claim 7, wherein the transmitter of the responder is configured to transmit a directional code which indicates an approximate bearing at which a vehicle must be travelling to be entering or leaving the station.

10. A data logging system as claimed in claim 9, wherein each of the one or more data loggers is configured to determine, based on the bearing on its compass and the directional code received from the responder, whether the vehicle is entering or leaving the station.

11. (canceled)

12. A data logging system as claimed in claim 7, wherein a directional code associated with each responder is recorded in the memory of each of the one or more data loggers, and upon receipt of the identification signal from the responder, the respective data logger is configured to determine, based on the bearing on its compass and the directional code stored in its memory, whether the vehicle is entering or leaving the station.

13. A data logging system as claimed in claim 1, wherein each of the one or more data loggers includes a real time clock for providing time code signals which are recorded in the memory.

14. A data logging system as claimed in claim 1, wherein the device configured to indicate when the vehicle is in operation comprises a vehicle operation detector for providing an indication of whether the vehicle is being operated, the vehicle operation indication being recorded in the memory.

15. (canceled)

16. (canceled)

17. (canceled)

18. A data logging system as claimed in claim 14, wherein the vehicle operation detector comprises a magnetometer which is sensitive to changes in magnetic field strengths as the vehicle moves.

19. (canceled)

20. A data logging system as claimed in claim 18, wherein the magnetometer also functions as a compass which is sensitive to the direction of travel of the respective vehicle for providing an indication of whether the detected vehicle is entering or leaving the station, the indication being recorded with the identification data in the memory.

21. (canceled)

22. A data logging system as claimed in claim 1, wherein the device configured to indicate when the vehicle is occupied comprises a vehicle occupant detector for providing an indication of whether the vehicle is occupied by a driver, the vehicle occupant indication being recorded in the memory.

23. (canceled)

24. A data logging system as claimed in claim 1, wherein the responder is programmable with a delayed start to conserve power and minimise RF traffic.

25. A responder for use in a data logging system for recording data relating to the usage of one or more vehicles of a fleet of vehicles operating from a station, comprising:
a magnetometer which is sensitive to changes in the Earth's magnetic field for detecting movement of a vehicle nearby; and
a transmitter configured to transmit an identification signal identifying the responder following output from the magnetometer.

26. A responder as claimed in claim 25, wherein the transmitter is configured to respond to output from the vehicle detector by transmitting the identification signal identifying the responder upon detection of a vehicle movement.

27. A responder as claimed in claim 25, wherein the transmitter is configured to respond to output from the vehicle detector by transmitting an interrogation signal upon detection of a vehicle movement, and the responder further comprises a receiver for receiving a response to the interrogation signal, the transmitter also configured to respond to output from the receiver by transmitting the identification signal identifying the responder upon receipt of a response to the interrogation signal by the receiver.

28. A responder as claimed in claim 25, wherein the transmitter is configured to transmit a directional code which indicates an approximate bearing at which a vehicle must be travelling to be entering or leaving the station.

29. A responder as claimed in claim 25, comprising a housing having a mounting part which is attachable to a support surface, the magnetometer mounted within the housing at an angle which is adjustable relative to the mounting part to maintain the magnetometer in a substantially horizontal configuration.

30. A responder as claimed in claim 25 and comprising a housing having a mounting part which is attachable to a support surface, and further comprising one or more solar cells for charging a storage device which powers the responder, the angle of the solar cell(s) being adjustable relative to the mounting part.

31. A data logger For recording data relating to the usage of one or more vehicles of a fleet of vehicles operating from one or more stations, comprising:
a logger receiver for receiving an identification signal;
a compass which is sensitive to the direction of travel of the vehicle for providing an indication of whether the vehicle is entering or leaving the station; and
a memory configured to record identification data derived from the received identification signal and data derived from the indication of whether the vehicle is entering or leaving the station.

32. A data logger as claimed in claim 31, wherein the compass comprises a magnetometer.

33. A data logger as claimed in claim 31, wherein the receiver is configured to receive a directional code from a responder which indicates an approximate bearing at which a vehicle must be travelling to be cntering or leaving the station, and the data logger is configured to determine, based on the bearing on its compass and the directional code received from the responder, whether the vehicle is entering or leaving the station.

34. (canceled)

35. A data logger as claimed in claim 31, wherein a directional code associated with each responder is stored in the memory of the data logger, and upon receipt of the identification signal from the responder the data logger is configured to determine, based on the bearing on its compass and the directional code stored in its memory, whether the vehicle is entering or leaving the station.

36. A data logger as claimed in claim 31, including a real time clock for providing time code signals which are recorded in the memory.

37. A data logger as claimed in claim 31, comprising or in combination with a device configured to indicate when the vehicle is in operation and/or a device configured to indicate when the vehicle is occupied to provide vehicle usage data, the memory configured to record the vehicle usage data.

38. A data logger as claimed in claim 37, wherein the device configured to indicate when the vehicle is in operation comprises a vehicle operation detector for providing an indication of whether the vehicle is being operated, the vehicle operation indication being recorded in the memory.

39. (canceled)

40. (canceled)

41. (canceled)

42. A data logger as claimed in claim 38, wherein the vehicle operation detector comprises a magnetometer which is sensitive to changes in magnetic field strengths as the vehicle moves.

43. (canceled)

44. A data logger as claimed in claim 42, wherein the magnetometer also functions as a compass which is sensitive to the direction of travel of the respective vehicle for providing an indication of whether the detected vehicle is entering or leaving the station, the indication being recorded with the identification data in the memory.

45. (canceled)

46. A data logger as claimed in claim 37, wherein the device configured to indicate when the vehicle is occupied comprises a vehicle occupant detector for providing an indication of whether the vehicle is occupied by a driver, the vehicle occupant indication being recorded in the memory.

47. A data logger as claimed in claim 31, comprising a mounting part for mounting in a cigarette lighter socket of a vehicle to power the data logger.

48. A data logger as claimed in claim 47, including a mechanical locking mechanism to selectively lock the mounting part in the cigarette lighter socket of the vehicle.

49. (canceled)

50. A data logger as claimed in claim 47, wherein the data logger comprises a cigarette lighter socket so that another device can draw power from the data logger when it is plugged into the cigarette lighter socket of a vehicle.

51. A data logger for recording data relating to the usage of one or more vehicles of a fleet of vehicles operating from one or more stations, comprising:
a housing having a mounting part for receipt in a cigarette lighter socket of a vehicle for powering the data logger;
and mounted within the housing a logger receiver for receiving an identification signal and a memory configured to record identification data derived from the received identification signal and the indication of whether the vehicle is entering or leaving the station;
the housing comprising a cigarette lighter socket for receipt of another device requiring power when the data logger is plugged into the cigarette lighter socket of the vehicle.

52. A data logger as claimed in claim 51, comprising a mechanical locking mechanism to selectively lock the mounting in the cigarette lighter socket of the vehicle.

53. A data logger as claimed in claim 52, wherein the mechanical locking mechanism comprises one or more retractable barbs which are engageable with the interior of the lighter socket of the vehicle.

54. A data logger as claimed in claim 53, wherein the barb(s) is/are pivotally mounted to a mounting member, which is mounted on a rotatable threaded member such that rotation of the threaded member results in movement of the mounting member and thereby movement of the barb(s).

55. A data logger as claimed in claim 54, comprising an adjusting head operably connected to the threaded member, such that rotation of the head results in rotation of the threaded member.

56. (canceled)

57. A data logger as claimed in claim 51, wherein the angle between the mounting part and the remainder of the housing is adjustable.
